(19) United States
(12) Patent Application Publication
(10) Pub. No.: US 2012/0215620 A1
(43) Pub. Date: Aug. 23, 2012

(54) Message Center Application and System

(76) Inventors: Ryan Scott Rodkey, Sugar Land, TX (US); John Frank Rodkey, JR., Missouri City, TX (US)

(21) Appl. No.: 13/031,108

(22) Filed: Feb. 18, 2011

(51) Int. Cl. G06Q 30/02

(52) U.S. Cl. 705/14.39

(57) ABSTRACT

A message system permits a commercial subscriber to create and store a message accessible by a consumer having the system application installed on his personal communication device for machine readable redemption at a point-of-sale or other redemption center. The system logs the redemption and activates rebates or payments from the commercial subscriber to the point-of-sale or other redemption center, in accordance with any agreement which may exist between the redemption center and the commercial subscriber.

### BACKGROUND OF THE INVENTION

1. Field of the Invention

Then invention is generally related to systems for operating applications installed on a digital communication device and is specifically directed to a digital coupon or other redemption system using a digital communication device.

2. Discussion of the Prior Art

Historically, a coupon is a ticket or document that can be exchanged for a financial discount or rebate when purchasing a product. Typically, coupons are issued by manufacturers of consumer packaged goods or by retailers, to be used in retail stores as a part of sales promotions. They are often widely distributed through mail, magazines, newspapers, a data gateway, and mobile devices such as cell phones. The origin of coupons dates back to 1888 when the Coca-Cola Company first introduced complimentary coupons for free Coca-Cola in magazines. In addition to paper coupons, electronic coupons are now issued as an electronic ticket solicited and or delivered by cellular phone to be used in the same manner for a financial discount or rebate when purchasing product or service.

Customarily coupons are issued by manufacturers of consumer packaged goods or retailers, to be used in retail stores as part of a sales promotion. They are often distributed through WAP Push over SMS or MMS, or other mobile means. The customer redeems the coupon at store or online Companies that provide mobile coupon services include Digimo, Mobiqa, Mobilitrix and Cellfire. In some cases customers redeem the mobile coupon at a retail store or other physical point of redemption and the retailers forward the redemption to a clearinghouse for final process. Once the redemption center accepts a coupon it typically accumulates like coupons over a period of time and forwards the coupons to the issuer or an authorized clearing house for redemption. This requires that the redemption center track and collect what is usually a small scrap of paper that is worth cash and mail or otherwise deliver the coupon to the issuer.

The electronic or mobile coupon, as well as many paper coupons, generally have machine readable indicia which permits capture of the information at the point of redemption, eliminating the need to collect the physical coupon and submit it for redemption.

In either case the coupons are collected, electronically or physically, and submitted for payment to the issuer or clearing house. In the case of paper coupons, the issuer lists the mailing address and states the terms applicable to point of redemption once the coupon is mailed to and received by the issuer or the authorized clearing house.

### SUMMARY OF THE INVENTION

The subject invention is directed to an application for a communication device and permits messages in the form of coupons, special offers and time and/or geographic sensitive information to be transmitted to a personal communication device such as a PDA, smart phone or other mobile personal communication device, or other devices with Data connectivity such as a laptop computer, I-Pad, or the like. Where desired, the messages can be configured into a format which is machine readable directly from the device for confirmation or redemption at a point-of-sale or point-of-use terminal. All messages are digitized and sent over a data transmission network, such as, by way of example, the Internet, eliminating the need for cellular network connectivity. When a message is activated by the device user, a use or redemption transmission is sent to the message sender, permitting automatic logging and management of message use activity. As an example, with respect to coupons, the redemption transmission would identify the point of redemption and permit issuers of coupons to track coupon redemption and to both collect payments from sponsors and distribute rebates to participating retailers. The system also permits messages to be activated for transmission based on time sensitive and/or geographic sensitive information. The application is installed on any device that has Data connectivity. This includes a cell phone, pda, computer, and the like.

One advantage of the system is that the automatic logging of use minimizes record keeping for redemption, collection and payments. In addition, the logging feature gives accurate, up-to-the-minute, use history, providing data for tracking response to various promotions and offers.

The message center may be activated by the user or by an application. For example, if the user is within a predetermined radius or zone of a redemption center, the application can notify the user of offers available or coupons redeemable at the center. In addition, should the user want to know about special offers and the user was not automatically notified by the application, the user may request offers available in the defined zone to be displayed on his device. The user may opt-in or opt-out of the automatic activation feature. In the redemption center may activate the system to notify any user when he enters the redemption center zone of coupons available in the zone, or other messages such as, by way of example, an opportunity to join a buyer's club or the like.

Another feature of the invention is the ability of the application to notify the user of price comparisons between competitors in a defined locale or area.

It is also possible to take photos or read bar codes of products at the redemption center to confirm the existence of applicable coupons or to add to a personal database so the coupons or messages applicable to the product are tracked for the user.

In addition, the system of the present invention permits text, voice and streaming video messages to be transmitted to a user whenever the user is in an applicable zone.

Another advantage of the system is the ability for a user to manage all coupons, offers and other informational messages on his personal communication device, wherein the specific messages are automatically presented based on the location of the user at any point in time by simply activating the message center on his device.

Other advantages and offers will be made readily apparent from the accompanying drawings and detailed description.

### BRIEF DESCRIPTION OF THE DRAWINGS

FIG. 1 is a general flow diagram showing typical flow of information during usage of the subject invention.

FIG. 2 is an exemplary system diagram.

FIG. 3 is a typical system diagram incorporating a social networking system into the message center system of the subject invention.

FIGS. 4-9 show typical icon selection and management of a system in accordance with the subject invention as loaded on a smart phone or the like.

### DETAILED DESCRIPTION

The subject invention is directed to a message center system, wherein an application may be installed on any device (preferably portable) having data connectivity. This permits commercial subscribers to transmit messages, offers, coupons and the like to consumer subscribers by pushing the information to the application installed on the consumer device, or by permitting the consumer to pull the information into his device on demand. The user may set his message center application to be activated one of several ways: 1. Manual activation controlled by the user, 2. Automatic activation controlled by a zone or location, and 3. When selected by the user, activated by the commercial subscriber whenever an offer or other message is transmitted by the commercial subscriber. Specifically, the application permits commercial subscribers to communicate continuously up-to-date messages and information to consumer subscribers anywhere Data connectivity is available, while permitting the consumer subscriber to “opt-in” or “opt-out” according to personal preference.

In essence, the invention permits the use of “smart phone” technology to send a message to a recipient by commercial subscribers to permit notification of time/location critical messages, offers or coupons by permitting the commercial subscriber to push a message to any user device having the message center application of the subject invention.

Because the application is not device dependent, it can be utilized with both wired and wireless communication apparatus, including, but not limited to smart phones, pda's, cell phones, computers, televisions, radios, interactive displays and basically any device having Data connectivity. Secure servers may be used for transmitting over secure channels, and unsecure channels may be used for social or non-sensitive communications. Messages may be encrypted and users may be required to be authenticated or password protected. Different levels of users may be established, with rights dependent on user level or priority.

The application is designed to be downloaded from the server to any device. An authorization code may be used to control downloads. Since all messages pass through a central server, messages may be audited and reports may be generated. All messages, regardless of format, are reconfigured into a single compatible data stream, permitting voice, text, video, images, and graphics to be sent in a single message, and reconfigured upon receipt into numerous formats. Messages may be private, to small groups, or broadcast over a large area, by selecting recipients, a specific group or channel, or merging multiple groups or channels.

An important feature of the invention is that when a user accepts or redeems an offer, it is automatically logged in at the point of redemption, providing a record of use, cancelling the offer on the user's device or account and generating redemption reports which are automatically sent from the point-of-use redemption center to the commercial subscriber/issuer, greatly streamlining the redemption, rebate and payment process.

The application will permit both encrypted and unencrypted messages to be sent. The transmissions may be password protected where desired. Individuals or groups may be recipients at the discretion of the sender. Public groups may be contacted, as well as private groups or individuals controlled at the device. Public groups and controlled groups may be maintained at a remote server.

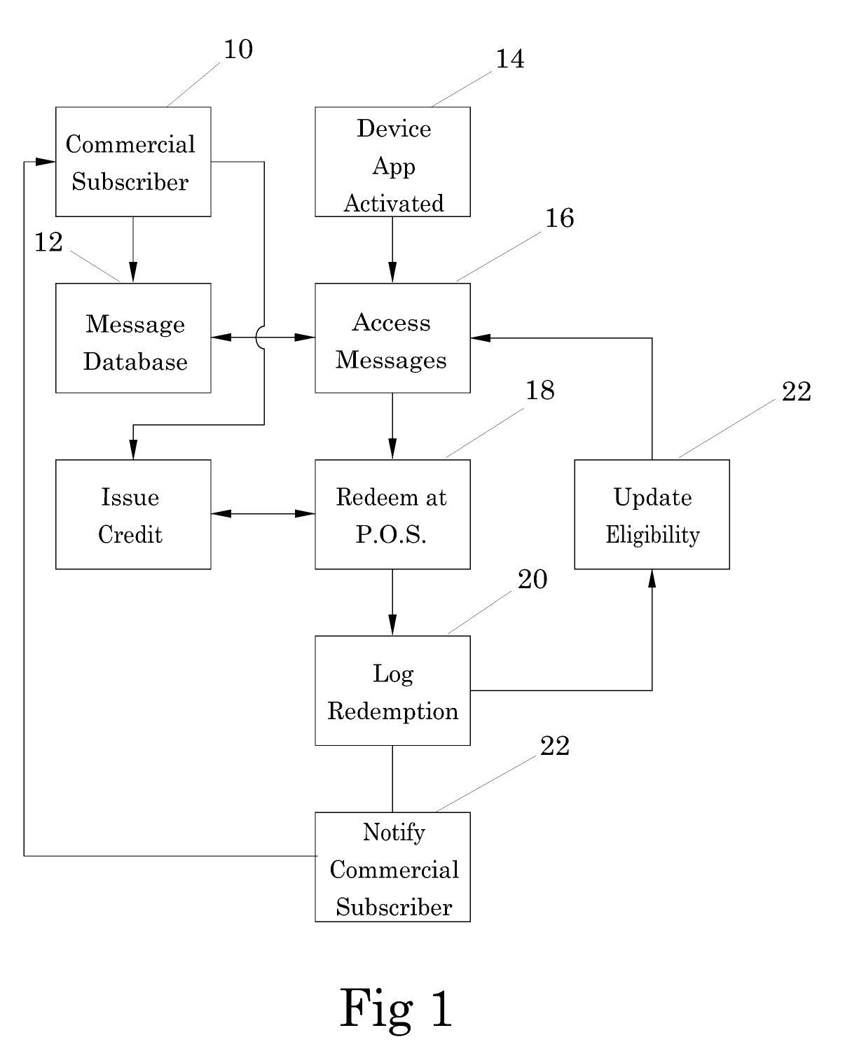

With specific reference to FIG. 1, initially a commercial subscriber 10 will create and store a message in the system database 12. The consumer having the system application installed on his device 14 may then access messages for which he is qualified as indicated at 16. The consumer's qualification criteria may be as simple as his presence in a specific point-of-redemption location or presence in a specific zone, which can be indicated by the gps tracking feature on the device 14. It may also be more controlled, such as by requiring the consumer to select certain features, such as a buying club or the like.

One the qualified messages are accessed, they will be presented on the device for machine readable redemption at the point-of-sale or other redemption center, as indicated at 18. The system then logs the redemption as indicated at 20, logging the message or coupon which has been redeemed, the point-of-sale participant, and the consumer information related to the specific device 14. At this point the consumer device is updated as indicated at 22, showing that the specific offer has been redeemed and that the offer is no long valid for redemption using the specific consumer device 14. This information is transmitted to the message database 12.

The logging function at 20 also generates notification to the commercial subscriber, as indicated at 22, activating rebates or payments from the commercial subscriber to the point-of-sale or other redemption center, in accordance with any agreement which may exist between the redemption center and the commercial subscriber.

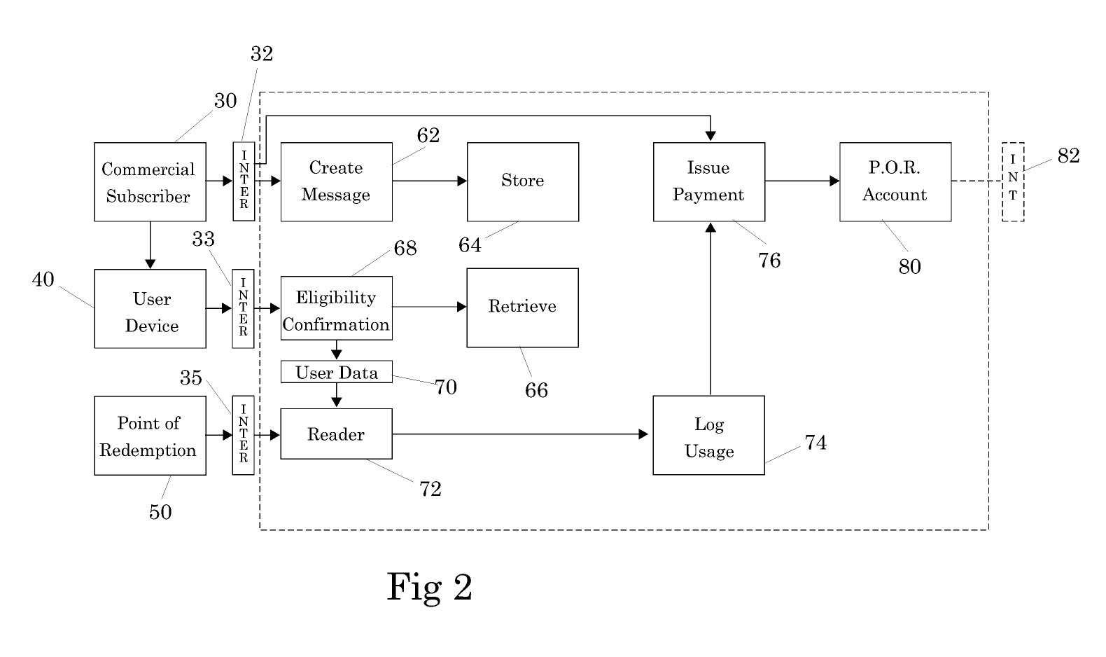

With specific reference to FIG. 2, in its broadest sense the invention is a system 60 for uploading consumer messages from a commercial subscriber 30 into a user device 40 for redemption using the user device. The system includes a message management system for receiving and storing messages as indicated at 62 and 64, messages being introduced into the system by a commercial subscriber 30 via an interface 32, whereby a message sender may communicate with and transmit consumer messages to the message management system. A consumer can then communicate with the system 60 via an interface 33, whereby a consumer message stored in the data store 64 may be accessed by the consumer, the consumer message being transmitted to a user controlled device 40. In the preferred embodiment the consumer message will include at least a portion in machine readable language. The system includes a redemption interface 35, whereby a point of redemption having a reader adapted for reading the machine readable language contained on the user controlled device may transmit data to the system 60 for indicating that the consumer message has been presented for redemption. The consumer message may be pushed (automatic transmission mode) through the consumer interface or pulled by the consumer (manual transmission mode) to the user controlled device, as will be described.

A typical use of the system is to permit the commercial subscriber to upload machine readable coupons which may be accessed and redeemed by the consumer using his user controlled device. Where desired, the system can house consumer criteria for defining consumer eligibility criteria, as indicated at 68. This permits the message management system to match selected consumer messages with selected consumers based on data in the consumer criteria database. Using the gps feature available on many user controlled device, the consumer criteria may include location of the user controlled device at the time the message is presented for redemption. At the option of the user, the consumer may select certain consumer messages in the system based on consumer selected criteria.

As shown in the system flow diagram of FIG. 2, the external participant, namely the consumer subscriber 30, the consumer through his user device 40, and the redemption center 50 access the system through a data interface of gateway 32. The system 60 comprises basically a remote server, a database, system software and communication gateways or interfaces 32. The communication gateways may be any gateway or in accordance with any protocol which is compatible with the data gateway. Thus, all data and all data management services occur within the system 60. Specifically, any commercial subscriber 30, user device 40 and redemption center 50 having Data connectivity may access the system 60 and the system 60 then manages all of the functions.

In a typical application, the commercial subscriber 30 will create a message 62 which will be stored in the system database, as indicated at 64. This message may be time sensitive, such as “for the next hour the redemption center at such-and-such location will be offering a discount on certain items.” The message may also be location sensitive, wherein the message is only accessible to consumers within a certain zone, as indicated by the gps tracking feature on the user device 40. The message may also be limited to specific groups of consumers, such as, by way of example, consumers who have subscribed to a buyer's club or the like. The message may also be a globally available message such as a coupon, promotional offer, or the like.

Once a message is available in the store 64, it may be pushed through to eligible user device 40, or where desired, may be accessed by the consumer when the consumer activates the application on his user device. This is indicated by the retrieve function 66, coupled with the eligibility function 68. It should be understood that eligibility criteria is a matter of choice, generally controlled by the commercial subscriber 60, and may range from global eligibility to specific group controlled eligibility. For example, some consumers, as identified by their user device 40, may only qualify if they have reached a threshold level of activity. By way of example, a consumer using his device and information loaded thereon, may qualify for an automatic upgrade if he has reached a certain use level, whereas other consumers may not be eligible for such an upgrade there, hence, would not be able to retrieve this information.

Once a consumer has qualified for a specific redeemable message, this information is presented on his user device 40 as machine readable user data, as indicted at 70. Specifically, the machine readable data on the user device 40 is collected at the point of redemption 50 and is entered into the system 60 via the interface or gateway 32, where it is verified at reader 72 by comparing the data input by the user device 40 with the user data 70 in the system.

At this point the eligible user device will permit the user to redeem the offer. The redemption will be logged by the system as indicated at log/usage function 74. The system then will issue payment in accordance with the agreement between the commercial subscriber and the redemption center, as indicated at 76, by crediting the redemption center's account 80.

As a matter of choice, the account may be maintained in the system, or may be ace ssed offsite via interface/gateway 82.

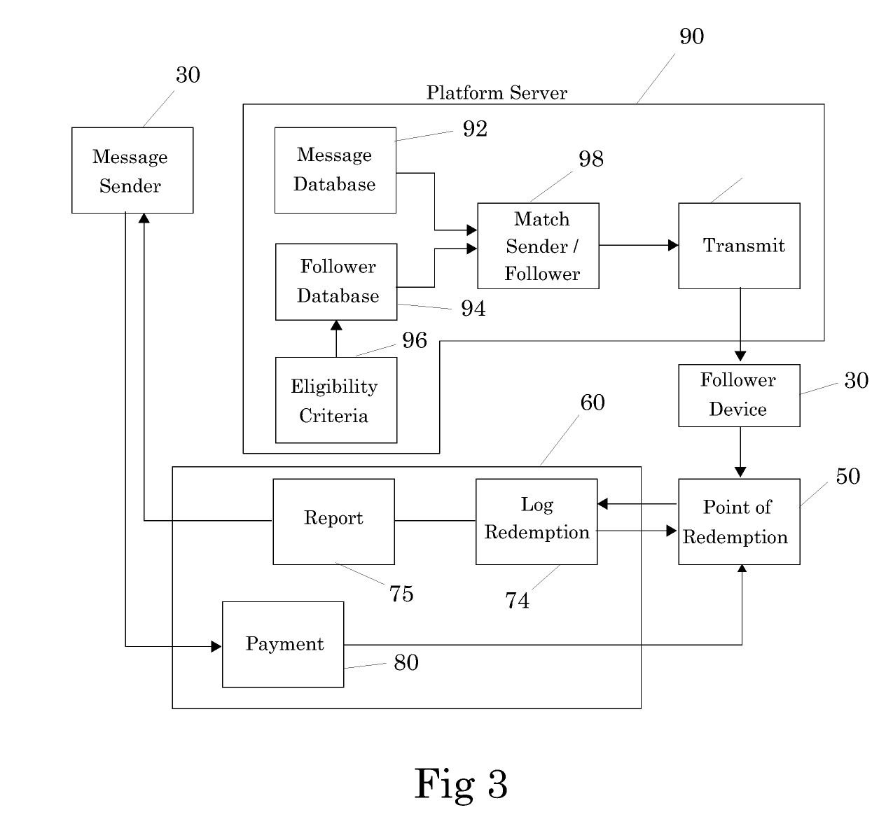

As shown in FIG. 3, the system 60 of the subject invention is ideally suited to be used in combination with social networking platforms such as, by way of example, Twitter. In this embodiment the message sender, or commercial subscriber 30 will access the platform server 90 and input the message to the platform database 92. As with other platform communications, the message will then be matched with the subscriber or follower database information indicated at 94, assuring eligibility as indicated at 96. This uses the platform system for matching senders (commercial subscribers) with followers (or user subscribers). Once it is determined that a match is made at 98 the message or messages are transmitted via the platform gateway, as indicated at 100, and received at the follower (or user subscriber) device 40, as a machine readable message which may be redeemed at the redemption center 50. As in the embodiment shown in FIG. 2, the redemption center then communicates with the system 60 of the present invention, for logging at 74, reporting at 75 (optional) and communicating with the sender 30, for updating the message database 92 and initiating payment as indicated at 80.

The combination of the social networking system 90 and the message sending and redemption system 60 of the subject invention may be further modified to provide a large catalog of messages as indicated in FIG. 2, with the same grouping and matching criteria as described in reference to FIG. 2.

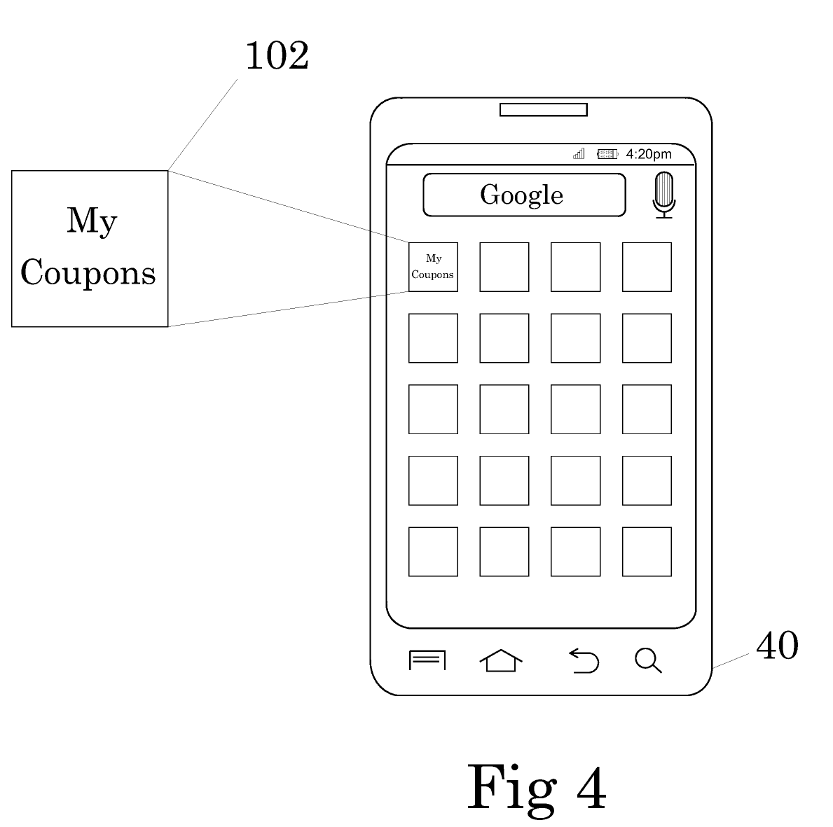

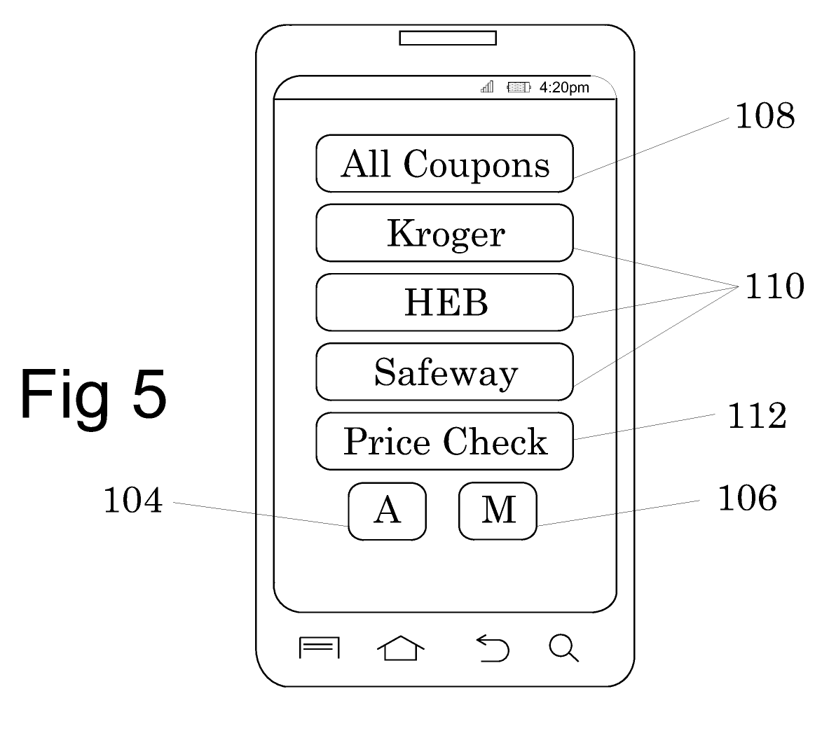

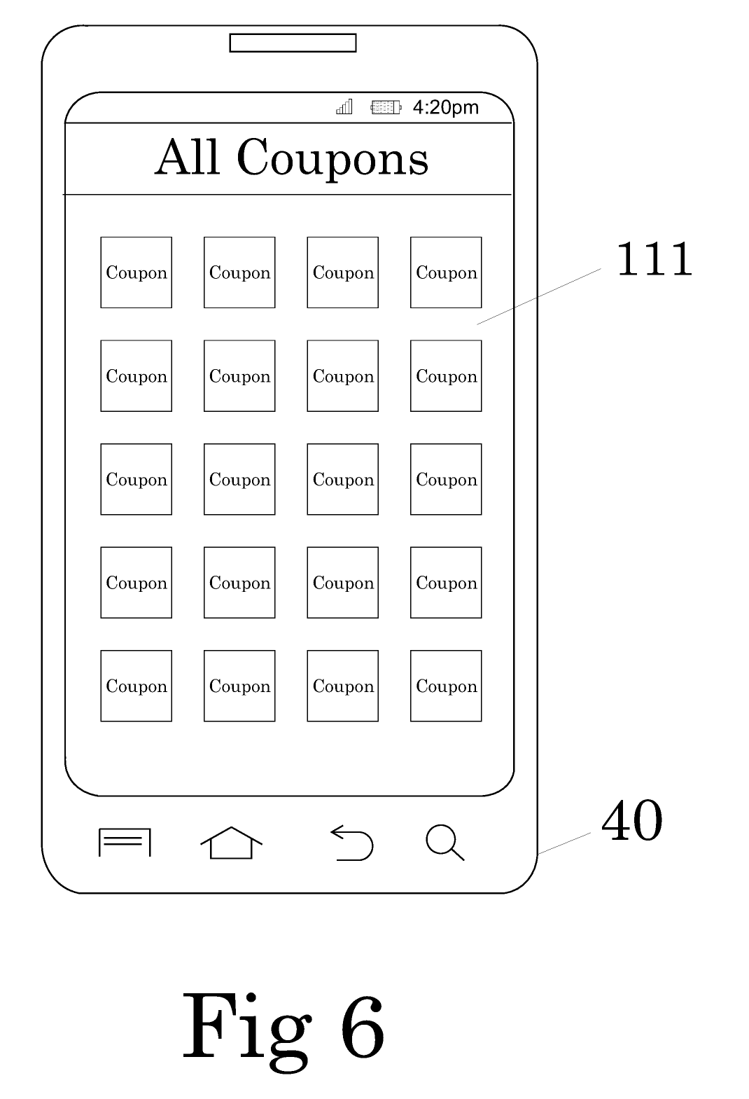

Various screen shots of a typical installation and operation are shown in FIGS. 4-9. The system is shown as installed on a smart phone 40, but it will be understood by those who are skilled in the art that any device with Data connectivity may be used. Typically, the screen will include a system icon such as “My Coupons” 102. The user may select an Auto function “A”, as indicated at 104 in FIG. 5, or in the alternative the Manual function “M” as indicated at 106. In auto function, the system will link the consumer/user to all coupons or messages pertinent to his and location at any time. In the manual function, the consumer will have the option of linking to all messages/coupons/offers relevant to his current qualification criteria, such as time and location, by selecting “All Coupons” 108. As shown in Screen 111 of FIG. 6, the coupons accessed may be listed in a scroll down menu, or the like. He may also select specific commercial subscribers of his choice, such as, by way of example “Kroger” 110. Any number of commercial subscribers may be added to this feature by manually typing in the commercial subscriber or by using a scroll down feature, as is well known by those who are skilled in the art.

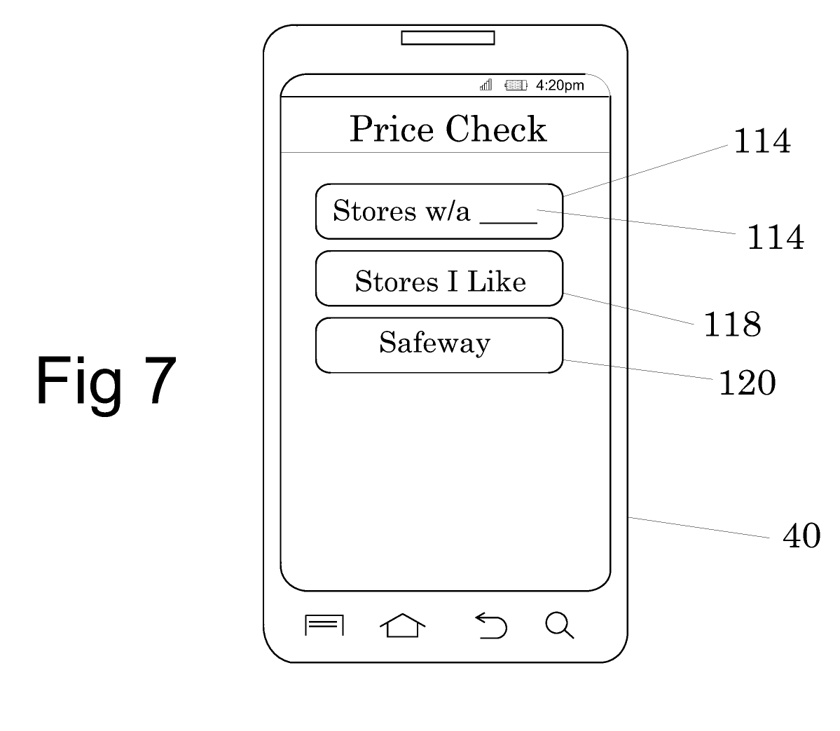

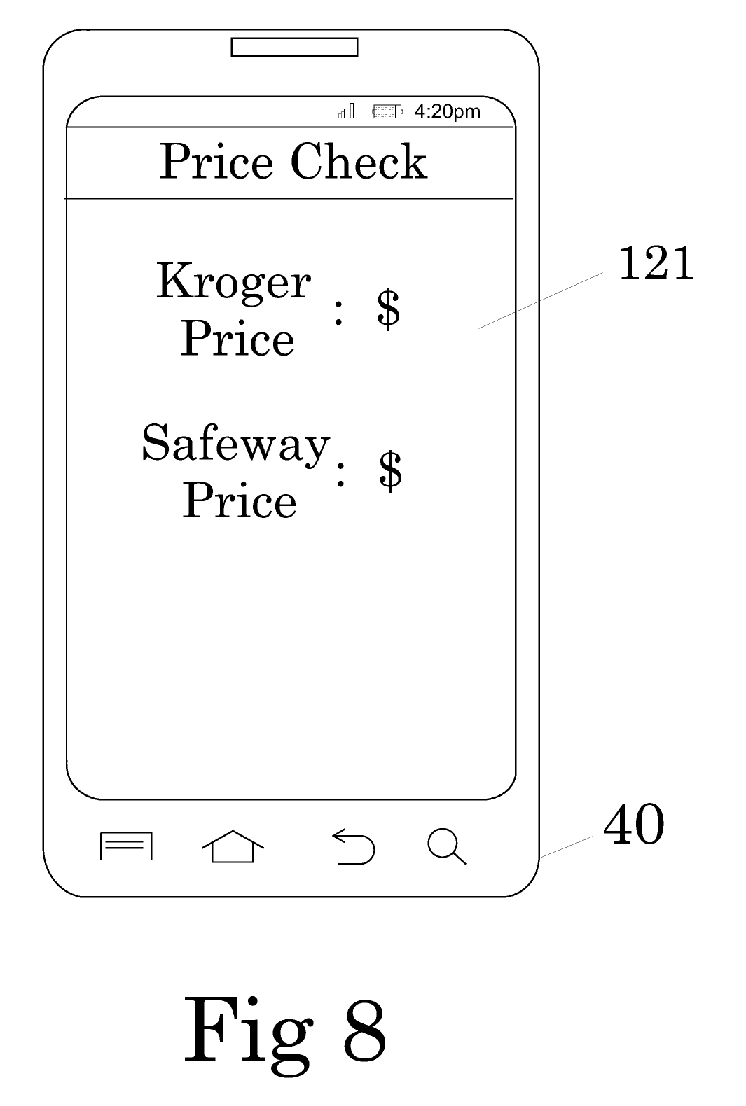

A “Price Check” 112 feature may also be accessed. When this feature is shown the screen 114 (FIG. 7) will be activated and the user may select any of several options, such as, by way of example, “Stores within 3 miles” 116, “Stores I like” 118 which have been previously selected, or specific stores such as “Safeway” 120 when comparing with Kroger, for example. By selecting the comparison redemption center, the screen 121(FIG. 8) will show the comparative prices for any item associated with a selected coupon for the two selected redemption centers.

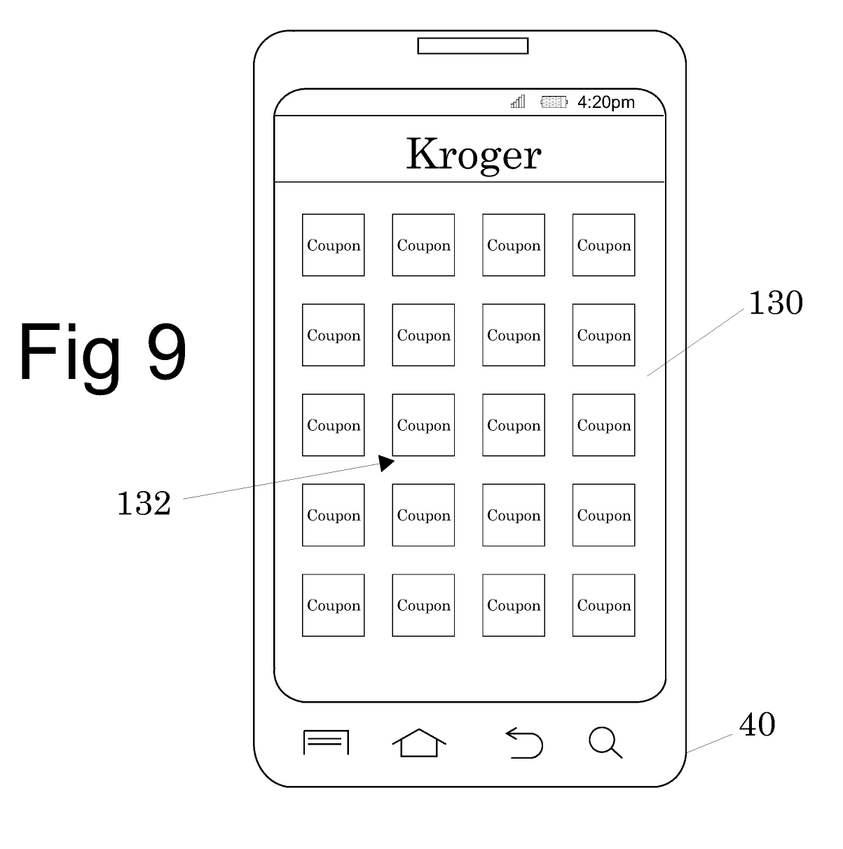

As shown in FIG. 9, once a group of coupons or messages has been selected, as indicated on the screen 130, the information will include at least a portion in a machine readable format 132, whereby the redemption center can read the selected message and begin the processing functions in accordance with the subject invention.

While certain features and embodiments of the invention have been described in detail herein, it should be understood that the invention includes all modifications and enhancements within the scope and spirit of the following claims.

1. A system for uploading consumer messages into a user device for redemption using the user device, the method comprising:
a. a message management system for receiving and storing messages;
b. a sender interface whereby a message sender may communicate with and transmit consumer messages to the message management system;
c. a consumer interface whereby a consumer message transmitted to the message management system may be accessed by the consumer, the consumer message being transmitted to a user controlled device and the consumer message having at least a portion thereof in machine readable language;
d. a redemption interface, whereby a point of redemption having a reader adapted for reading the machine readable language contained on the user controlled device, the redemption interface adapted for receiving a message and delivering it to the message management system for indicating that the consumer message has been presented for redemption.

2. The system of claim 1, wherein the consumer message is pushed through the consumer interface to the user controlled device.

3. The message interface of claim 1, wherein the consumer message is pulled through the consumer interface by the user controlled device.

4. The system of claim 1, wherein the consumer message is a redeemable coupon.

5. The system of claim 1, further including a consumer criteria database and the message management system further including a subsystem for matching selected consumer messages with selected consumers based on data in the consumer criteria database.

6. The system of claim 5, wherein the consumer criteria includes location of the user controlled device at the time the message is presented for redemption.

7. The system of claim 1, further including a subsystem permitting the consumer to select certain consumer messages in the system based on consumer selected criteria.

8. The system of claim 1, including a subsystem for logging the messages redeemed.

9. The system of claim 8, wherein the subsystem for logging the messages redeemed activates payments from the commercial subscriber to the point of redemption.
